(19) United States
(12) Patent Application Publication
(10) Pub. No.: US 2017/0084397 A1
(43) Pub. Date: Mar. 23, 2017

(54) Methods to Reduce Case Height for Capacitors

(71) Applicant: KEMET Electronics Corporation, Simpsonville, SC (US)

(72) Inventors: Keith Lee Moore, Simpsonville, SC (US); Philip M. Lessner, Simpsonville, SC (US); Chris Stolarski, Simpsonville, SC (US); James Allen Fife, Mound House, NV (US); Liancai Ning, Suzhou Jiangsu (CN)

(73) Assignee: KEMET Electronics Corporation

(21) Appl. No.: 15/263,812

(22) Filed: Sep. 13, 2016

Related U.S. Application Data
(60) Provisional application No. 62/219,743, filed on Sep. 17, 2015.

(51) Int. Cl. H01G 9/00; H01G 9/052; H01G 9/07; H01G 9/012

(52) U.S. Cl. CPC H01G 9/0029; H01G 9/012; H01G 9/0525; H01G 9/07; H01G 9/0032

(57) ABSTRACT

A method for forming a high aspect ratio sintered powder anode with low warpage, an anode made thereby and a cathode comprising the anode are provided. The method comprises placing a multiplicity of anode precursors on a forming substrate in a common plane wherein no more than 10% of the anode precursors are out of the common plane. A second substrate is then placed over the forming substrate with the anode precursors between the forming substrate and the second substrate thereby forming a sandwiched assembly. The sandwiched assembly is heated to a sintering temperature of the anode precursors thereby forming the sintered powder anodes. The and sintered powder anodes are removed from between the forming substrate and the second substrate.

### CROSS-REFERENCE TO RELATED APPLICATIONS

This application claims the benefit of priority under 35 U.S.C. section 119 to pending U.S. Provisional Patent Application No. 62/219,743 filed on Sep. 17, 2015 which is incorporated by reference.

### BACKGROUND

The invention is related to an improved method for forming anodes for electrolytic capacitors. More specifically, the present invention is related to a method for manufacturing anodes, preferably of valve metals, with a high aspect ratio and low warpage and capacitors formed therewith.

Miniaturization is an ongoing effort in the design and manufacture of electronics. A main component of miniaturization is increasing the space utilization of individual components. With capacitors, a critical component of most electronic devices, the goal is to increase the amount of capacitance in a given volume thereby providing the same, or improved, performance within a smaller space.

An exasperating reality with capacitors is that capacitance is a function of the overlap of the anode and cathode and therefore making a smaller anode surface necessarily decreases capacitance. Those of skill in the art of capacitor manufacture are faced with the contradictory conditions of an ongoing desire for miniaturization juxtaposed to the physical constraint that a smaller overlap between cathode and anode necessarily provides less capacitance.

One approach to miniaturization is to form ever thinner anodes thereby maintaining a high overlap area of anode and cathode yet the thinner anode reduces overall volumetric efficiency due to increased relative volume occupied by cathode materials external to the Ta anode. This approach has been marginally advantageous, however, the volumetric efficiencies expected have never been achieved with sintered powder anodes because the anode powder must be sintered and, during sintering, thin sintered powder anodes tend to warp more than thick sintered powder anodes thereby further reducing the volumetric efficiency which is contrary to the reason for using thinner anodes. The sintered powder anode therefore occupies more volume than desired as the case size of the ultimate capacitor must account for the warpage of the sintered powder anode. Those of skill in the art have an ongoing desire for planar sintered powder anode bodies with a high aspect ratio allowing thinner finished capacitors with high capacitance for miniaturization. Many efforts have focused on achieving high aspect ratio sintered powder anodes with minimal warpage yet none have been successful.

One method has been to sinter anodes while constantly rotating the anode during sintering to evenly distribute heat. It was hypothesized that eliminating the constant effect of gravity on the anode body would promote homogenous heat distribution and facilitate planer anodes and eliminates the establishment of metallic bonds between adjacent anodes or other materials while sintering. Though marginally successful the manufacturing difficulty, and minimum improvements on warpage, renders this technique unsuitable for large scale use.

The present invention provides a method for manufacturing anodes of high aspect ratio, yet with minimal warpage, thereby allowing for a significant improvement in volumetric efficiency or capacitance per unit volume.

### SUMMARY OF THE INVENTION

It is an object of the invention to provide an improved method of manufacturing an anode, and a capacitor made therewith, wherein the anode has a high aspect ratio and minimal warpage.

These and other embodiments, as will be realized, are provided in a method for forming a high aspect ratio sintered powder anode with low warpage comprising:

placing a multiplicity of anode precursors on a forming substrate in a common plane wherein no more than 10% of the anode precursors are out of the common plane;
placing a second substrate over the forming substrate with the anode precursors between the forming substrate and the second substrate thereby forming a sandwiched assembly;
heating the sandwiched assembly to a sintering temperature of the anode precursors thereby forming the sintered powder anodes; and
removing the sintered powder anodes from between the forming substrate and the second substrate.

Yet another embodiment is provided in a method for forming a capacitor comprising:

forming a high aspect ratio sintered powder anode with low warpage by:
placing a multiplicity of anode precursors on a forming substrate;
placing a second substrate over the forming substrate with the anode precursors between the forming substrate and the weighted substrate thereby forming a sandwiched assembly;
heating the sandwiched assembly to a sintering temperature of the anode precursors thereby forming the sintered powder anodes; and
removing the sintered powder anodes from between the forming substrate and the second substrate;
forming a dielectric on the sintered powder anodes; and
forming a cathode on the dielectrics.

Yet another embodiment is provided in a capacitor comprising:

a sintered powder anode having an aspect ratio of at least 10 and a warpage of no more than 20%;
an anode wire in electrical contact with the sintered powder anode;
a dielectric on the sintered powder anode; and
a cathode on the dielectric.

### BRIEF DESCRIPTION OF FIGURES

FIG. 1 is a partially exploded schematic representation of an embodiment of the invention.

FIG. 2 is a partially exploded schematic representation of an embodiment of the invention.

FIG. 3 is a partially exploded schematic representation of an embodiment of the invention.

FIG. 4 is a graphical representation of an embodiment of the invention.

FIG. 5 is a schematic representation of an embodiment of the invention.

FIG. 6 is a schematic representation of an embodiment of the invention.

FIG. 7 is a schematic cross-sectional representation of an embodiment of the invention.

### DESCRIPTION

The present invention is related to a method of forming an improved anode and a capacitor formed therewith. More specifically, the present invention is related to a method of forming an anode with a high aspect ratio, and minimal warpage, thereby allowing for a capacitor with improved volumetric efficiency.

The invention will be described with reference to the figures forming an integral non-limiting component of the disclosure. Throughout the description similar elements will be numbered accordingly.

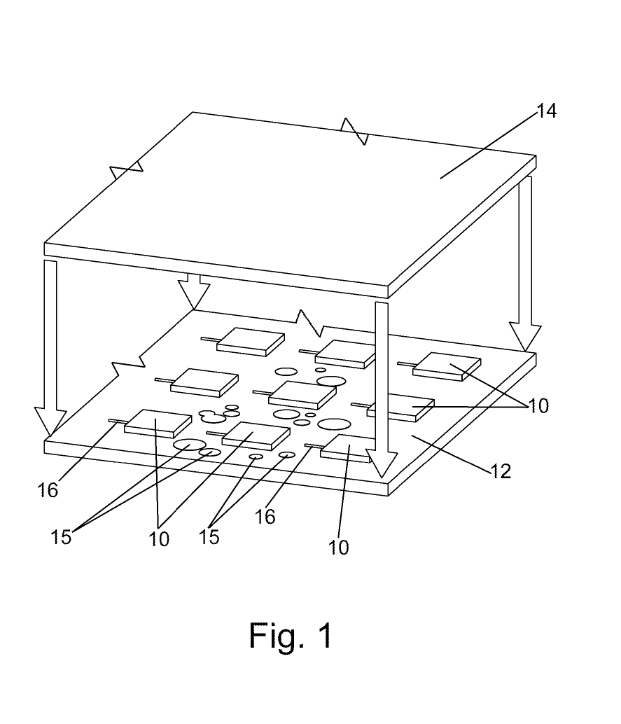

An embodiment of the invention will be described with reference to FIG. 1 wherein a sandwiched assembly is illustrated schematically in partially expanded view. In FIG. 1, at least one anode precursor, 10, is sandwiched between a formation substrate, 12, and an optional weighted substrate, 14, wherein the formation substrate and weighted substrate may be substantially the same in form and composition. The anode precursor may be a dry free-flowing powder or a powder incorporated into a paste. An anode wire, 16, is optionally embedded in the anode precursor prior to sintering. In one embodiment the formation substrate and weighted substrate are brought together into close parallel engagement forming a sandwich assembly which is then heated to sinter the anode precursor in accordance with standard manufacturing procedures. By forming a sandwich assembly the anode precursor is constrained between adjacent substrates, in one embodiment, thereby minimizing the warpage that typically occurs during sintering and cool down. The result is a planar sintered powder anode which is then removed from between the substrates for subsequent processing to form a capacitor. In another embodiment the weighted substrate is a second formation substrate with anode precursor thereon. The second formation substrate may be elevated, relative to the anode precursor on the lower formation substrate. The multiplicity of anode precursors, 10, are preferably substantially all co-planer with no more than 10% of the anode precursors being out of the common plane. By avoiding stacked anode precursors the number of warped anodes is significantly decreased. Each section of anode precursor, 10, may result in a discrete sintered powder anode or larger sintered powder anodes may be prepared which are subsequently segmented into smaller discrete sintered powder anodes as described elsewhere herein. When multiple anode precursors are co-sintered, and therefore in a common sandwiched relationship, it is preferable that the commonly sandwiched anode precursors, and subsequent sintered powder anodes, are all the same thickness. A low charge powder, 15, is preferably spread on the formation plate prior to the introduction of the anode precursor. The low charge powder provides a protective bed between the anode precursor and formation plate thereby decreasing the formation of metallurgical bonds, or mechanical bonding, of the sintered anode to the formation plate. The low charge powder is preferably the same composition as the anode precursor with the exception of a lower charge density. After sintering any low charge powder that adheres to the surface of the sintered anode is insignificant.

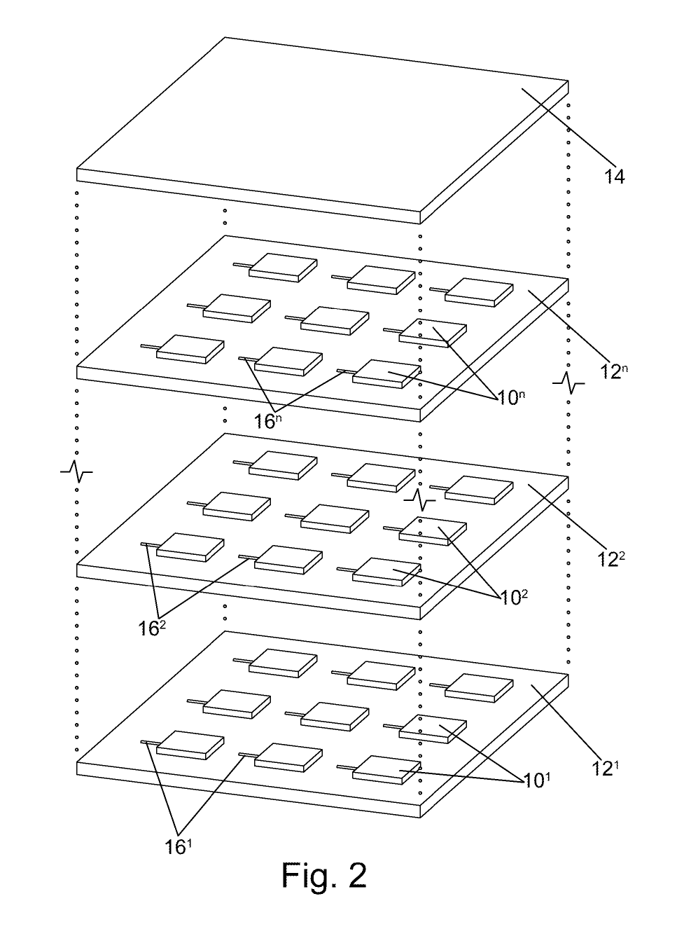

An embodiment of the invention will be described with reference to FIG. 2 wherein a sandwiched assembly is illustrated schematically in partially expanded view. In FIG. 2 a series of formation substrates, 12, each with a multiplicity of anode precursors, 10, thereon forms a multilayered sandwiched assembly with an optional weighted substrate, 14, on top. Each formation substrate may be the same and the weighted substrate may be the same as a formation substrate. In FIG. 2 the number of forming substrates in a stack is represented by the superscript “n” representing the first substrate, second substrate, etc. The number of layers is limited by weight, particularly when an engaged sandwich is formed, since it is preferable that the anodes not be crushed. The number is also limited by heat transfer efficiencies since a large number of alternating stacks may limit the ability to heat the entire stack uniformly. About 1 to about 10 layers of forming substrates is preferred. An engaged sandwich is defined herein as a sandwich assembly wherein adjacent substrates are both in contact with the anode precursor there between. A separated sandwich is defined herein as an assembly wherein an upper substrate is elevated above the anode precursor on a lower adjacent substrate.

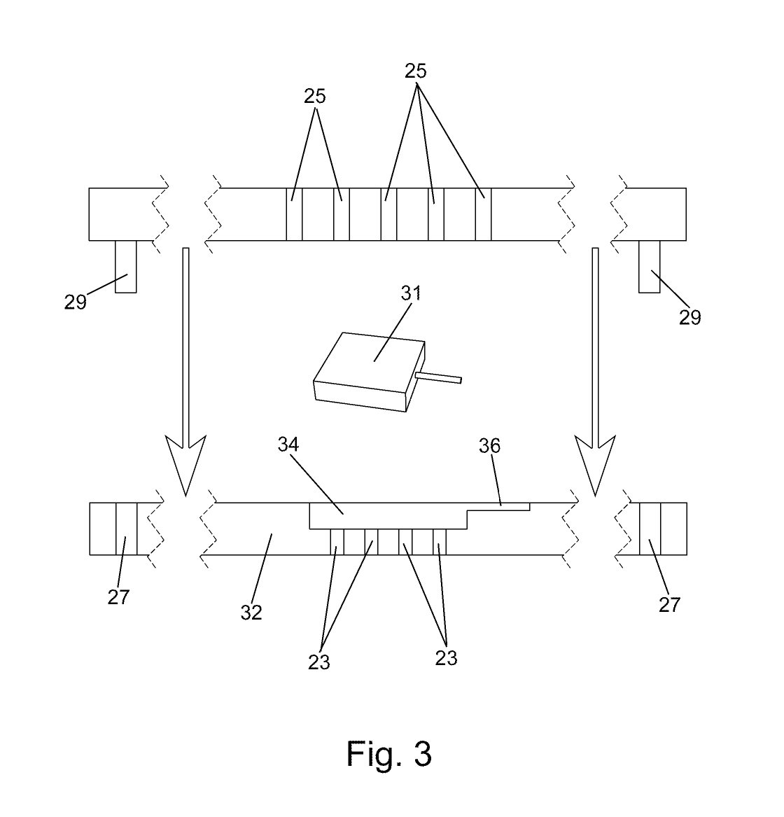

The invention will be described with reference to FIG. 3 wherein an embodiment of the invention is illustrated schematically in exploded cross-sectional view after sintering. In FIG. 3, a forming substrate, 32, comprises an anode cavity, 34, within which the anode precursor is placed for sintering to form the sintered precursor anode, 31. If a wire is to be embedded in the anode precursor a wire cavity, 36, is preferably employed. In use, the anode cavity is filled with anode powder, preferably in the form of a powder or a paste, and the anode wire is placed in the wire cavity such that a portion of the anode wire extends into the anode powder. The anode powder may be pre-pressed and placed in the pocket for sintering or the substrate with the cavity can be used as a pressing die. In one embodiment, the weighted substrate and forming substrate are brought into engaging relationship to form an engaged sandwich and the anode precursor there between is sintered while in a sandwiched relationship between the substrates. As would be realized, multiple forming substrates may be used in a stack with up to all of the forming substrates comprising anode cavities and up to all adjacent substrates forming an engaged sandwich. The substrates may have a registration element insuring adjacent plates maintain proper relative orientation. A representative registration element is illustrated as a hole, 27, and mating pin, 29, which may be depressions and protrusions. In some embodiments it is preferable to have weighted substrate voids, 25, or forming substrate voids, 23, to facilitate thermal removal of solvent and other volatile components. In another embodiment at least one of the upper or lower substrate can comprise a removable die with an array of through holes to facilitate compaction. In another embodiment the substrate, or a cavity in the substrate, can be porous. Much higher un-sintered densities, and thus sintered densities, can be reached compared to paste alone. A wire can be inserted before, or attached after, the vacuum sintering.

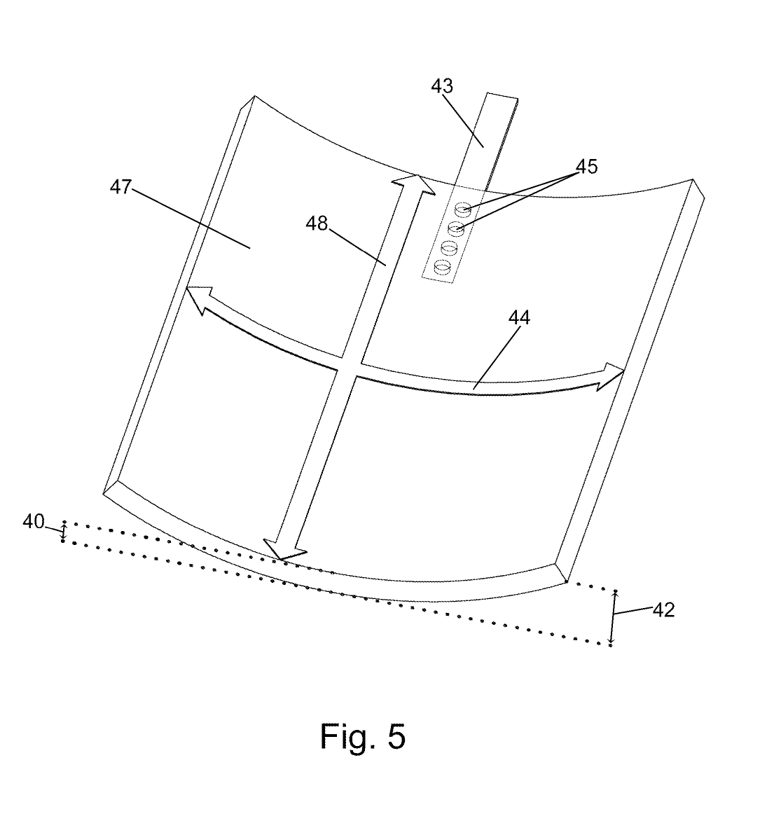

A particular advantage of the invention is the ability to provide an anode with a very high aspect ratio with minimal warpage. The aspect ratio is defined herein as the ratio of the diameter of a circle, having an equivalent area to the largest face of the sintered powder anode, to the average thickness. With reference to FIG. 5, and using a rectangle as an example, the aspect ratio is defined by first defining the diameter of a circle with the same surface area as the face, 47, having a width, 44, and a height, 48, for the purposes of demonstration. The aspect ratio is then the ratio of the diameter to the average thickness generally represented at 40. The warpage is defined as the ratio of maximum deviation from planarity, 42, to the average thickness generally represented at 40. It is preferred that the aspect ratio be at least 10 to no more than 400. Below an aspect ratio of 10 the advantages with regards to miniaturization are insufficient. Above an aspect ratio of about 400 the sintered powder anode would be difficult to handle in subsequent manufacturing operations. It is more preferable that the aspect ratio be at least 20. The warpage is measured as an absolute warpage, however, it is appropriately considered as a percentage of anode thickness. A warpage of no more than 20%, relative to the average thickness, is preferred with a warpage of no more than 10%, relative to the average thickness, being most preferred. Above a warpage of 20% the volumetric efficiency advantages are not realized. It is preferable to have no warpage. The wire, 43, preferably comprising voids, is embedded in the powder prior to sintering.

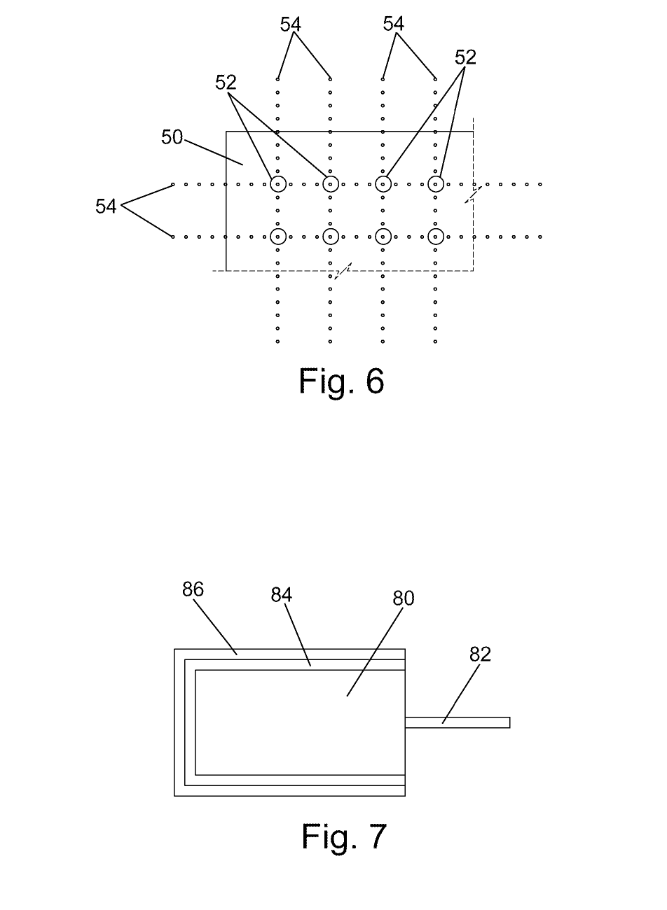

A particular advantage of the instant invention is the ability to form a large sintered powder anode, followed by dicing, to form smaller sintered powder anodes. An embodiment will be described relative to FIG. 6 wherein a sintered powder anode sheet, 50, is illustrated schematically in partial top view. The sintered powder anode sheet, 50, may comprise voids, 52, which facilitate separation of the discrete sintered powder anodes from the sintered powder anode sheet. The sintered powder anode sheet is diced along cut lines, 54, thereby providing a large number of discrete sintered powder anodes. Each sintered powder anode will then have an anode wire attached thereto such as by welding. If the sintered powder anode sheet is completely sintered prior to attachment of the anode wire a deoxygenation step may be required prior to wire attachment.

Substrates are preferably made of materials that have a softening point well above the sintering temperature of the anode precursor and are preferably formed of materials that will not permanently contaminate the sintered powder anode. Ceramic substrates comprising a material that will not alloy or otherwise chemically react with valve metals, such as Ta or TaO, are preferred with a preference for ceramics that are soluble in mineral acids. Exemplary materials include MgO, alumina and tantalum. MgO has a melting point of about 2,852° C. which is well above normal sintering temperatures and is a preferred material in some embodiments. MgO substrates also allow for leaching away any MgO adhering to the anode after the sintering operation. Alumina, Al₂O₃, has a melting point of 2,072° C. and is a preferred material in some embodiments. A particularly suitable substrate is Ta, or another metal, coated with a material that has release or lubricity properties such as alumina, metal oxides particularly MgO or Ta₂O₅, metallic nitride particularly TaN or any other material capable of preventing Ta to Ta metallurgical bonding, provides a synergistic advantage. Contamination from the substrates may be removed by post sintering leaching.

The anode precursors used for the sintered powder anode preferably comprise valve metal powders. Particularly preferred valve metal powders include Al, W, Ta, Nb, Ti, Zr, Hf and conductive oxides thereof. More preferably, the anode precursor comprises a material selected from the group consisting of Al, Nb, Ta and NbO.

The wire is not particularly limited herein. Anode wires made of the same material as the anode are particularly suitable for manufacturing conveniences. The wire may be embedded in the anode precursor, as described herein, or the wire may be welded to an at least partially sintered anode using any welding technique known in the art. A wire with voids is particularly preferred particularly when the wire is embedded in the anode precursor prior to sintering.

In another embodiment a porous backbone can be formed by fibers thereby forming a sponge like structure as set forth in U.S. Pat. No. 5,284,531 which is incorporated herein by reference, wherein the localized density gradients can be minimized and adhesion improved. Fibers can also be used in concert with anode precursor. By way of example a blend of Ta fiber with Ta powder can be used to strengthen the sintered powder anode and control the shrinkage or warpage pattern. The purpose is to minimize anode warpage of thin sintered powder anodes by influencing the rate of expansion and contraction during sintering. In a related embodiment flakes can be used instead of, or in addition to, nodular powder or fibrous powder. The shrinkage behavior of flake can reduce the amount of warpage.

Some of the warpage that occurs during sintering is theorized to be due to the density gradients imparted in the anode precursor due to compression in and around the embedded anode wire. In an embodiment of the invention the anode wire is either a valve metal foil or a valve metal flat wire with voids therein with tantalum being the preferred valve metal. The voids in the wire promote mechanical strength, or adhesion, to the anode precursor and minimize the differences in localized press densities.

The temperature ramp rate of heating and/or cooling is theorized to impact the warping of anode precursors during sintering. A slow ramp and cool down rate is preferred as this is hypothesized to promote homogenous distribution of temperature across the anode precursor while sintering thereby possibly controlling uneven shrinkage which increases warpage. More preferably, the temperature cycle can include stepwise sintering with slow ramping and frequent hold times. By way of example, the temperature change can be at a rate of 1° C./min to 300° C./min and more preferably at least 15° C./min. Hold times can be at fixed or variable increments such as a hold time at each increase in temperature of 10-120° C. for a time sufficient to allow the temperature to equilibrate within the anode. As the temperature increases the increments may become at closer intervals of temperature. The sintering is preferably at a temperature of 1,000° C. to less than 1,500° C. unless the wire is excluded during sintering in a separated sandwich. The sintering soak time is preferable less than 60 minutes in duration.

In an embodiment of the invention a continuous heating can be implemented. The initial heating is typically used to remove the lubricants used to facilitate pressing of a valve metal precursor. A continuous heating cycle, from ambient to sintering, can be used to initially remove impurities with continued temperature increase to sintering temperature. A continuous heating cycle eliminates exposure of delubed sintered powder anode pore structure, wherein the lubricant has been vaporized, to impurities which may otherwise influence uneven solid state melt behavior of the valve metal particles while sintering. Particular impurities to be avoided include oxygen, nitrogen, and hydrogen. The anode wire can be attached after an initial sintering such as by welding.

A capacitor is illustrated schematically in cross-sectional view in FIG. 7. In FIG. 7, the sintered powder anode, 80, has an anode wire, 82, in electrical contact therewith. A dielectric layer, 84, encases at least a portion of the sintered powder anode and a cathode, 86, encases a portion of the dielectric. After formation of the sintered powder anode a dielectric is formed as known in the art. The dielectric is not particularly limited herein. As would be realized to those of skill in the art electrical connection is made to the anode wire and cathode to incorporate the capacitor into a case or circuit.

Particularly preferred for demonstration of the invention is a dielectric oxide of the anode material due to manufacturing conveniences and wide spread use in the art.

A cathode is formed on the dielectric as known in the art. The cathode is a conductor and is not otherwise limited herein. Particularly preferred for demonstration of the invention is a cathode formed from at least one of manganese dioxide or a conductive polymer both of which are widely practiced in the art. A particularly preferred conductive polymer is a thiophene such as polymerized 3,4-polyethylene dioxythiophene (PEDT).

It is known in the art that formation of an adhesive bond to manganese dioxide or conductive polymer layers is difficult. It is therefore standard in the art to form subsequent coatings to improve adhesion between the cathode and conductive lead.

Conductive carbon containing layers and metal filled layers, as widely practiced in the art, are suitable for demonstration of the invention.

### EXAMPLES

For demonstration of the invention a tantalum powder with Scott density in excess of 1.7 g/cc and preferably in excess of 1.9 g/cc and more preferably in excess of 2.0 g/cc can be employed in a 0.254 mm (0.010 inch) thick anode format as described herein. These powders provide a sintered density in excess of 5.0 g/cc and preferably around 6.5 g/cc. In each case the substrate type, arrangement of anodes and sintering temperature and sintering time were varied and the warpage presented as indicated in Table 1.

### Example 1

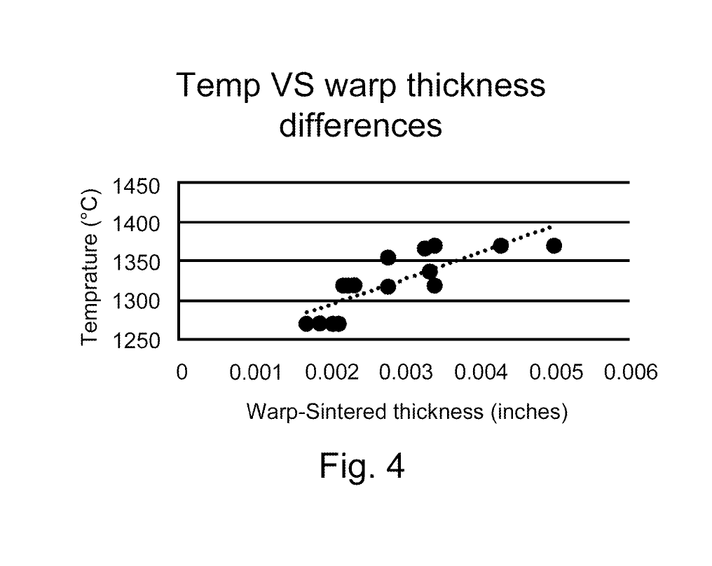

A 80,000 CV/g tantalum powder was pressed to a press density of 5.5 g/cc-6.5 g/cc and a press thickness of 0.23 mm (0.009 inches). The pressed powder was sintered in the temperature ranges of 1260° C.-1370° C. as piled anodes in an open container. As illustrated graphically in FIG. 4 the anode shows warpage wherein the warp linear thickness, as a function of temperature, is approximately linear relative to the sintered linear thickness.

### Example 2

Example 1 was repeated forming an 0.354 mm thick anode wherein the sintering was done with a single layer of anodes placed between bare Ta plate substrates in an engaged sandwich. Example 2 illustrates the warpage due to temperature.

### Example 3

Example 2 was repeated with the exception of Nitrided Ta plate substrates in place of bare Ta plate substrates in an engaged sandwich. Example 3 illustrates the warpage due to temperature.

### Example 4

Example 2 was repeated with the exception of the sintering which was done with a single layer of anodes placed on a bare Ta substrate in a separated sandwich. Examples 4A and 4B demonstrate the invention.

### Example 5

Example 4 was repeated with the exception of the use of a nitrided Ta substrate. Example 5 illustrates the warpage due to temperature.

### Example 6

Example 2 was repeated with the exception of the sintering which was done with a single layer of anodes in an separated sandwich with the substrate dusted with a layer of low charge Ta powder. Example 6 illustrates the warpage due to temperature.

### Example 7

Example 2 was repeated with the exception of the sintering which was done with a single layer of anodes. Examples 7A and 7B were done in an engaged sandwich and Examples 7C-7F were done in a separated sandwich. Examples 7A-7D were sintered without a wire whereas Examples 7E and 7F had a wire embedded prior to sintering. Examples 7A and 7C-7E illustrate inventive example.

TABLE 1

| | Sintering | Sintering soak | Warpage |
|---|---|---|---|
| Example | Temp (° C.) | time (min) | (%) |
| 1A | 1375 | 45 | 50 |
| 1B | 1320 | 45 | 33 |
| 2 | 1400 | 15 | 42 |
| 3 | 1400 | 15 | 29 |
| 4A | 1300 | 15 | 5 |
| 4B | 1300 | 45 | 10 |
| 4C | 1400 | 45 | 59 |
| 5 | 1400 | 15 | 28 |
| 6 | 1400 | 15 | 25 |
| 7A | 1300 | 45 | 4 |
| 7B | 1400 | 45 | 40 |
| 7C | 1300 | 45 | 4 |
| 7D | 1400 | 45 | 10 |
| 7E | 1300 | 45 | 14 |
| 7F | 1400 | 45 | 53 |

The invention has been described with reference to the preferred embodiments without limit thereto. One of skill in the art would realize additional embodiments and improvements which are not specifically set forth but which are within the scope of the invention as set forth in the claims appended hereto.

Claimed is:

1. A method for forming a high aspect ratio sintered powder anodes with low warpage comprising:
placing a multiplicity of anode precursors on a forming substrate in a common plane wherein no more than 10% of said anode precursors are out of said common plane;
placing a second substrate over said forming substrate with said anode precursors between said forming substrate and said second substrate thereby forming a sandwiched assembly;
heating said sandwiched assembly to a sintering temperature of said anode precursors thereby forming said sintered powder anodes; and
removing said sintered powder anodes from between said forming substrate and said second substrate.

2. The method for forming a high aspect ratio sintered powder anodes with low warpage of claim 1 wherein said sandwiched assembly is selected from an engaged sandwich and a separated sandwich.

3. The method for forming a high aspect ratio sintered powder anodes with low warpage of claim 1 wherein said sintered powder anodes have an aspect ratio of at least 10.

4. The method for forming a high aspect ratio sintered powder anodes with low warpage of claim 3 wherein said sintered powder anodes have an aspect ratio of at least 20.

5. The method for forming a high aspect ratio sintered powder anodes with low warpage of claim 1 wherein said sintered powder anodes have a warpage of no more than 20% relative to the sintered powder anodes thickness.

6. The method for forming a high aspect ratio sintered powder anodes with low warpage of claim 5 wherein said sintered powder anodes have a warpage of no more than 10% relative to the sintered powder anodes thickness. The method for forming a high aspect ratio sintered powder anodes with low warpage of claim 1 further comprising placing an anode wire in at least one anode precursor of said anode precursors prior to said heating.

8. The method for forming a high aspect ratio sintered powder anodes with low warpage of claim 7 wherein said anode wire comprises voids.

9. The method for forming a high aspect ratio sintered powder anodes with low warpage of claim 1 further comprising electrically attaching an anode wire to said sintered powder anodes after at least some said heating.

10. The method for forming a high aspect ratio sintered powder anodes with low warpage of claim 1 wherein at least one of said forming substrate or said second substrate comprises voids.

11. The method for forming a high aspect ratio sintered powder anodes with low warpage of claim 1 wherein said forming substrate or said second substrate comprises at least one anode cavity.

12. The method for forming a high aspect ratio sintered powder anodes with low warpage of claim 11 wherein said forming substrate or said second substrate comprises at least one anode wire cavity.

13. The method for forming a high aspect ratio sintered powder anodes with low warpage of claim 1 wherein said anode precursors comprise a material selected from the group consisting of Al, W, Ta, Nb, Ti, Zr, Hf and conductive oxides thereof.

14. The method for forming a high aspect ratio sintered powder anodes with low warpage of claim 13 wherein said anode precursors comprise a material selected from the group consisting of Al, Nb, Ta and NbO.

15. The method for forming a high aspect ratio sintered powder anode with low warpage of claim 1 wherein said sintering is at a temperature of 1,000° C. to less than 1,500° C.

16. The method for forming a high aspect ratio sintered powder anodes with low warpage of claim 1 wherein at least one of said second substrate or said forming substrate comprises a material selected from the group consisting of MgO, Al₂O₃, Ta, TaN, Ta₂O₅ and TaO.

17. The method for forming a high aspect ratio sintered powder anodes with low warpage of claim 1 further comprising dicing at least one sintered powder anode.

18. The method for forming a high aspect ratio sintered powder anodes with low warpage of claim 1 wherein said sintering temperature is 1,000° C. to less than 1,500° C.

19. A method for forming a capacitor comprising:
forming a high aspect ratio sintered powder anode with low warpage by:
placing a multiplicity of anode precursors on a forming substrate;
placing a second substrate over said forming substrate with said anode precursors between said forming substrate and said weighted substrate thereby forming a sandwiched assembly;
heating said sandwiched assembly to a sintering temperature of said anode precursors thereby forming at least one said sintered powder anode; and
removing said sintered powder anode from between said forming substrate and said second substrate;
forming a dielectric on said sintered powder anode; and
forming a cathode on said dielectric.

20. The method for forming a capacitor of claim 19 wherein said sintered powder anode has an aspect ratio of at least 10.

21. The method for forming a capacitor of claim 20 wherein said sintered powder anode has an aspect ratio of at least 20.

22. The method for forming a capacitor of claim 19 wherein said sintered powder anode has an warpage of no more than 20% relative to the sintered powder anode thickness.

23. The method for forming a capacitor of claim 22 wherein said sintered powder anode has an warpage of no more than 10% relative to the sintered powder anode thickness.

24. The method for forming a capacitor of claim 19 further comprising placing an anode wire in said anode precursor prior to said heating.

25. The method for forming a capacitor of claim 24 wherein said anode wire comprises voids.

26. The method for forming a capacitor of claim 19 further comprising electrically attaching an anode wire to said sintered powder anode after at least some said heating.

27. The method for forming a capacitor of claim 19 wherein at least one of said forming substrate or said second substrate comprises voids.

28. The method for forming a capacitor of claim 19 wherein said forming substrate or said second substrate comprises at least one anode cavity.

29. The method for forming a capacitor of claim 19 wherein said forming substrate or said second substrate comprises at least one anode wire cavity.

30. The method for forming a capacitor of claim 19 wherein said anode precursors comprise a material selected from the group consisting of Al, W, Ta, Nb, Ti, Zr, Hf and conductive oxides thereof.

31. The method for forming a capacitor of claim 30 wherein said anode precursors comprise a material selected from the group consisting of Al, Nb, Ta and NbO.

32. The method for forming a capacitor of claim 19 wherein said sintering is at a temperature of 1,000° C. to less than 1,500 ° C.

33. The method for forming a capacitor of claim 19 wherein at least one of said second substrate or said forming substrate comprises a material selected from the group consisting of MgO, Al₂O₃, Ta, TaN, Ta₂O₅ and TaO.

34. The method for forming a capacitor of claim 19 wherein said cathode comprises a material selected from manganese dioxide and a conductive polymer.

35. The method for forming a capacitor of claim 34 wherein said conductive polymer comprises a thiophene.

36. The method for forming a capacitor of claim 35 wherein said thiophene is polymerized 3,4-polyethylene dioxythiophene.

37. The method for forming a capacitor of claim 19 wherein said sintering temperature is 1,000° C. to less than 1,500° C.

38. The method for forming a capacitor of claim 19 further comprising dicing at least one said sintered powder anode.

39. A capacitor comprising:
a sintered powder anode having an aspect ratio of at least 10 and a warpage of no more than 20%;
an anode wire in electrical contact with said sintered powder anode;
a dielectric on said sintered powder anode; and
a cathode on said dielectric.

40. The capacitor of claim 39 wherein said aspect ratio is at least 20.

41. The capacitor of claim 39 wherein said sintered powder anode has an warpage of no more than 20% relative to the anode thickness.

42. The capacitor of claim 39 wherein said anode wire comprises voids.

43. The capacitor of claim 39 wherein said sintered powder anode comprises a material selected from the group consisting of Al, W, Ta, Nb, Ti, Zr, Hf and conductive oxides thereof.

44. The capacitor of claim 43 wherein said sintered powder anode comprises a material selected from the group consisting of Al, Nb, Ta and NbO.
